(19) United States
(12) Patent Application Publication
(10) Pub. No.: US 2013/0257837 A1
(43) Pub. Date: Oct. 3, 2013

(54) LIQUID CRYSTAL DISPLAY DEVICE, DRIVING CIRCUIT, AND DRIVING METHOD THEREOF

(71) Applicant: Jinjie Wang, Shenzhen (CN)

(72) Inventor: Jinjie Wang, Shenzhen (CN)

(73) Assignee: SHENZHEN CHINA STAR OPTOELECTRONICS TECHNOLOGY CO. LTD., Sheznhen (CN)

(21) Appl. No.: 13/510,575

(22) PCT Filed: Mar. 30, 2012
(86) PCT No.: PCT/CN12/73310

§ 371 Date: May 17, 2012

(30) Foreign Application Priority Data
Mar. 28, 2012 (CN) 201210086412.2

(51) Int. Cl. G09G 3/36

(52) U.S. Cl. CPC G09G 3/3696
USPC 345/211

(57) ABSTRACT

A method for driving liquid crystal display device includes: supplying a scan signal to at least some of column-wise pixel units in a column of a liquid crystal display device; applying a data signal supplied from a data signal source to the pixel units of the column to which the scan signal is supplied after supplying the scan signal to the at least some of the column-wise pixel units of the column; supplying a scan signal to another portion of the column-wise pixel units of the column of the liquid crystal display device after applying the data signal to the at least some of the pixel units; and applying the data signal supplied from the data signal source to said another portion of the pixel units to which the scan signal is supplied after supplying the scan signal to said another portion of the column-wise pixel units of the column.

### BACKGROUND OF THE INVENTION

1. Field of the Invention

The present invention relates to the field of liquid crystal displaying techniques, and in particular to a liquid crystal display device, a driving circuit, and a driving method thereof.

2. The Related Arts

A liquid crystal display device often comprises an array substrate, a color filter substrate, and a liquid crystal layer arranged between the array substrate and the color filter substrate. The liquid crystal display device comprises a plurality of pixel units, each of which comprises a pixel electrode that is made of indium tin oxide (ITO) and disposed on the array substrate and a common electrode disposed on the color filter substrate. The pixel electrode and the common electrode of the color filter substrate constitute a liquid crystal capacitor.

To drive the liquid crystal display device, the prior art techniques use an array substrate that is shown in FIG. 1. The array substrate comprises column-wise scan lines 101 and row-wise data lines 103 that intersect but is not in conduction with the scan lines 101 and pixel electrodes 105 and thin film transistors 107 that are respectively set in a plurality of unit areas formed by division effected by the scan lines 101 and the data lines 103. Data drivers and scan drivers (not shown) are respectively connected to the data lines 103 and the scan lines 101. The thin film transistors 107 of the same column have gate terminals that are electrically connected to the same, closest scan line. The thin film transistors 107 of the same row have source terminals that are electrically connected to the same, closest data line. Each thin film transistor 107 has a drain terminal that is electrically connected to the pixel electrode 105 of the same unit area.

When the data lines receive data signals from the data drivers and the scan lines receive scan signals from the scan drivers, the voltage levels of the pixel electrodes change so that the voltage that is applied across the liquid crystal capacitor changes, causing the orientation of the liquid crystal molecules contained in the liquid crystal layer to change thereby effecting control of the transmittance of light through the pixel and thus controlling the displayed brightness of each pixel.

However, in the conventional structure, taking a liquid crystal display device having m×n resolution as an example, a number of 3m data lines and a number of n scan lines are needed. If the data driver and the scan driver are respectively of a and b channels, then the number of data drivers and scan drivers used are respectively 3m/a and n/b. The cost of the data driver is higher than that of the scan driver and thus, the manufacturing cost is high.

### SUMMARY OF THE INVENTION

The primary technical issue to be addressed by the present invention is to provide a liquid crystal display device, a driving circuit, and a driving method thereof, which reduces the cost of manufacturing by reducing the number of data drivers used to achieve the same resolution.

To address the above technical issue, the present invention adopts a solution by providing a liquid crystal display device, which comprises first and second substrates that are opposite to each other and a liquid crystal layer interposed between the first and second substrates, wherein the first substrate comprise a plurality of pixel units that is arranged in an array having columns and rows and a plurality of scan drivers, a plurality of data drivers, a plurality of first switch units, and a plurality of second switch units that are located outside the array of the pixel units; each of the pixel units comprises a row-wise data line, column-wise first and second scan lines, a pixel electrode and a controllable switch located in an area enclosed by the data lines and the scan lines, wherein in each column of the pixel units, control terminals of the controllable switches of odd rows are electrically connected to the first scan line, control terminals of the controllable switches of even rows are electrically connected to the second scan line, input terminals of the controllable switches are electrically connected to the data lines, and output terminals of the controllable switches are electrically connected to the pixel electrode, in which the controllable switches are first thin film transistors; each of the first switch units corresponds to one of the channels of the scan drivers and a column of the pixel units, each of the first switch units comprising an input terminal, a first output terminal, and a second output terminal, the input terminal of the first switch unit being electrically connected to one of the channels of the scan drivers, the first output terminal of the first switch unit being electrically connected to the first scan line, the second output terminal of the first switch unit being electrically connected to the second scan line in order to selectively supply a scan signal from one of the channels of the scan drivers to the pixel units of the same column that are associated with the odd rows or the even rows; each of the second switch units corresponds to one of channels of the data drivers and two rows of the pixel units, each of the second switch units comprising an input terminal, a first output terminal, and a second output terminal, the input terminal of the second switch unit being electrically connected to one of the channels of the data drivers, the first output terminal of the second switch unit being electrically connected to the data line of an odd row, the second output terminal of the second switch unit being electrically connected to the data line of an adjacent even row, in order to selectively supply a data signal from one of the channels of the data drivers to the adjacent odd row or even row of the pixel units; the first switch unit comprises: a first selection line, a second selection line, a third selection line, a fourth selection line, and a low level signal line that are arrange row-wise; a first driver supplying a voltage level selection signal to the first selection line, the second selection line, the third selection line, and the fourth selection line and supplying a low level voltage to the low level signal line; a first field effect transistor having a gate terminal electrically connected to the first selection line, the first field effect transistor having a source terminal electrically connected to one of the channels of the scan driver, the first field effect transistor having a drain terminal electrically connected to the first scan line; a second field effect transistor having a gate terminal electrically connected to the second selection line, the second field effect transistor having a source terminal electrically connected to the channel of the scan driver, the second field effect transistor having a drain terminal electrically connected to the second scan line; a third field effect transistor having a gate terminal electrically connected to the third selection line, the third field effect transistor having a source terminal electrically connected to the low level signal line, the third field effect transistor having a drain terminal electrically connected to the first scan line; and a fourth field effect transistor having a gate terminal electrically connected to the fourth selection line, the fourth field effect transistor having a source terminal electrically connected to the low level signal line, the fourth field effect transistor having a drain terminal electrically connected to the second scan line; wherein when the first driver supplies a high voltage level to the first selection line and the fourth selection line and supplies a low voltage level to the second selection line, the third selection line, and the low level signal line, the first field effect transistor and the fourth field effect transistor are set on and the second field effect transistor and the third field effect transistor are set off, whereby a scan signal supplied from one of the channels of the scan drivers is transmitted via the first field effect transistor to the first scan line and a low voltage level signal supplied from the low level signal line is transmitted via the fourth field effect transistor to the second scan line in order to selectively supply the scan signal to the odd-row pixel units of the same column; and when the first driver supplies a high voltage level to the second selection line and the third selection line and supplies a low voltage level to the first selection line, the fourth selection line, and the low level signal line, the second field effect transistor and the third field effect transistor are set on and the first field effect transistor and the fourth field effect transistor are set off, whereby a scan signal supplied from the channel of the scan driver is transmitted via the second field effect transistor to the second scan line and a low voltage level signal supplied from the low level signal line is transmitted via the third field effect transistor to the first scan line in order to selectively supply the scan signal to the even-row pixel units of the same column; the second switch unit comprises: a fifth selection line and a sixth selection line that are arranged column-wise; a second driver supplying a voltage level selection signal to the fifth selection line or the sixth selection line; the fifth field effect transistor having a gate terminal electrically connected to the fifth selection line, the fifth field effect transistor having a source terminal electrically connected to one of the channels of the data driver, the fifth field effect transistor having a drain terminal electrically connected to the data line of one of the odd rows; and the sixth field effect transistor having a gate terminal electrically connected to the sixth selection line, the sixth field effect transistor having a source terminal electrically connected to the channel of the data driver, the sixth field effect transistor having a drain terminal electrically connected to the data line of the adjacent even row; wherein when the second driver supplies a high voltage level to the fifth selection line and supplies a low voltage level to the sixth selection line, the fifth field effect transistor is set on and the sixth field effect transistor is set off, whereby a signal supplied from one of the channels of the data driver is transmitted via the fifth field effect transistor to the data line of one of the odd rows to selectively supply a data signal to the pixel units of the same odd row; and when the second driver supplies a high voltage level to the sixth selection line and supplies a low voltage level to the sixth selection line, the sixth field effect transistor is set on and the fifth field effect transistor is set off, whereby a signal supplied from the channel of the data driver is transmitted via the sixth field effect transistor to the data line of an adjacent even row in order to selectively supply a data signal to the pixel units of the same even row.

Wherein, each of the second switch units corresponds to two rows of the pixel units.

To address the above technical issue, the present invention adopts another solution by providing a liquid crystal display driving circuit, which comprises: a plurality of scan drivers, a plurality of data drivers, a plurality of first switch units, and a plurality of second switch units that are located outside an array of pixel units of a liquid crystal display device; each of the pixel units comprises a row-wise data line, at least two column-wise scan lines, a pixel electrode and a controllable switch located in an area enclosed by the data lines and the scan lines, wherein in each column of the pixel units, a control terminal of each of the controllable switches is electrically connected to one the scan lines, input terminals of the controllable switches are electrically connected to the data lines, and output terminals of the controllable switches are electrically connected to the pixel electrode; each of the first switch units corresponds to one of the channels of the scan drivers and a column of the pixel units, each of the first switch units comprising an input terminal and at least two output terminals, the input terminal of the first switch unit being electrically connected to one of the channels of the scan drivers, the output terminals of the first switch unit being respectively and electrically connected to the scan lines in order to selectively supply a scan signal from one of the channels of the scan drivers to the pixel units of the same column that are electrically connected with one of the scan lines; and each of the second switch units corresponds to one of channels of the data drivers and at least two rows of the pixel units, each of the second switch units comprising an input terminal and at least two output terminals, the input terminal of the second switch unit being electrically connected to one of the channels of the data drivers, each of the output terminals of the second switch unit being electrically connected to one of the data lines in order to selectively supply a data signal from one of the channels of the data drivers to the pixel units of one row of the at least two rows of pixel units to which the scan signal is supplied.

Wherein, the controllable switches comprise first thin film transistors; each of the pixel units comprises column-wise first and second scan lines, wherein in each column of the pixel units, gate terminals of the first thin film transistors of the odd rows are electrically connected to the first scan line and gate terminals of the thin film transistors of the even rows are electrically connected to the second scan line; each of the first switch units comprises a first output terminal and a second output terminal, the first output terminal of the first switch unit being electrically connected to the first scan line, the second output terminal of the first switch unit being electrically connected to the second scan line in order to selectively supply a scan signal from one of the channels of the scan drivers to the pixel units of the same column that are associated with the odd rows or the even rows; each of the second switch units comprises a first output terminal and a second output terminal, the first output terminal of the second switch unit being electrically connected to the data line of an odd row, the second output terminal of the second switch unit being electrically connected to the data line of an adjacent even row, in order to selectively supply a data signal from one of the channels of the data drivers to the adjacent odd row or even row of the pixel units; wherein when the first switch unit selectively supplies a scan signal to the odd-row pixel units of one column, the second switch units selectively supply data signals to the odd rows of the pixel units; and when the first switch unit selectively supplies a scan signal to the even-row pixel units of the same column, the second switch units selectively supply data signals to the even rows of the pixel units.

Wherein, the first switch unit comprises: a first selection line, a second selection line, a third selection line, a fourth selection line, and a low level signal line that are arrange row-wise; a first driver supplying a voltage level selection signal to the first selection line, the second selection line, the third selection line, and the fourth selection line and supplying a low level voltage to the low level signal line; a first field effect transistor having a gate terminal electrically connected to the first selection line, the first field effect transistor having a source terminal electrically connected to one of the channels of the scan driver, the first field effect transistor having a drain terminal electrically connected to the first scan line; a second field effect transistor having a gate terminal electrically connected to the second selection line, the second field effect transistor having a source terminal electrically connected to the channel of the scan driver, the second field effect transistor having a drain terminal electrically connected to the second scan line; a third field effect transistor having a gate terminal electrically connected to the third selection line, the third field effect transistor having a source terminal electrically connected to the low level signal line, the third field effect transistor having a drain terminal electrically connected to the first scan line; and a fourth field effect transistor having a gate terminal electrically connected to the fourth selection line, the fourth field effect transistor having a source terminal electrically connected to the low level signal line, the fourth field effect transistor having a drain terminal electrically connected to the second scan line; wherein when the first driver supplies a high voltage level to the first selection line and the fourth selection line and supplies a low voltage level to the second selection line, the third selection line, and the low level signal line, the first field effect transistor and the fourth field effect transistor are set on and the second field effect transistor and the third field effect transistor are set off, whereby a scan signal supplied from one of the channels of the scan drivers is transmitted via the first field effect transistor to the first scan line and a low voltage level signal supplied from the low level signal line is transmitted via the fourth field effect transistor to the second scan line in order to selectively supply the scan signal to the odd-row pixel units of the same column; and when the first driver supplies a high voltage level to the second selection line and the third selection line and supplies a low voltage level to the first selection line, the fourth selection line, and the low level signal line, the second field effect transistor and the third field effect transistor are set on and the first field effect transistor and the fourth field effect transistor are set off, whereby a scan signal supplied from the channel of the scan driver is transmitted via the second field effect transistor to the second scan line and a low voltage level signal supplied from the low level signal line is transmitted via the third field effect transistor to the first scan line in order to selectively supply the scan signal to the even-row pixel units of the same column.

Wherein, the second switch unit comprises: a fifth selection line and a sixth selection line that are arranged column-wise; a second driver supplying a voltage level selection signal to the fifth selection line or the sixth selection line; the fifth field effect transistor having a gate terminal electrically connected to the fifth selection line, the fifth field effect transistor having a source terminal electrically connected to one of the channels of the data driver, the fifth field effect transistor having a drain terminal electrically connected to the data line of one of the odd rows; and the sixth field effect transistor having a gate terminal electrically connected to the sixth selection line, the sixth field effect transistor having a source terminal electrically connected to the channel of the data driver, the sixth field effect transistor having a drain terminal electrically connected to the data line of the adjacent even row; wherein when the second driver supplies a high voltage level to the fifth selection line and supplies a low voltage level to the sixth selection line, the fifth field effect transistor is set on and the sixth field effect transistor is set off, whereby a signal supplied from one of the channels of the data driver is transmitted via the fifth field effect transistor to the data line of one of the odd rows to selectively supply a data signal to the pixel units of the same odd row; and when the second driver supplies a high voltage level to the sixth selection line and supplies a low voltage level to the sixth selection line, the sixth field effect transistor is set on and the fifth field effect transistor is set off, whereby a signal supplied from the channel of the data driver is transmitted via the sixth field effect transistor to the data line of an adjacent even row in order to selectively supply a data signal to the pixel units of the same even row.

Wherein, each of the second switch units corresponds to two rows of the pixel units.

To address the above technical issue, the present invention adopts a further solution by providing a method for driving liquid crystal display device, comprising the following steps: supplying a scan signal to at least some of column-wise pixel units in a column of a liquid crystal display device; applying a data signal supplied from a data signal source to the pixel units of the column to which the scan signal is supplied after supplying the scan signal to the at least some of the column-wise pixel units of the column; supplying a scan signal to another portion of the column-wise pixel units of the column of the liquid crystal display device after applying the data signal to the at least some of the pixel units; and applying the data signal supplied from the data signal source to said another portion of the pixel units to which the scan signal is supplied after supplying the scan signal to said another portion of the column-wise pixel units of the column.

Wherein, the step of supplying a scan signal to at least some of column-wise pixel units in a column of a liquid crystal display device comprises supplying the scan signal to the pixel units of the column of the liquid crystal display device that are associated with odd rows; the step of applying a data signal supplied from a data signal source to the pixel units of the column to which the scan signal is supplied after supplying the scan signal to the at least some of the column-wise pixel units of the column comprises supplying a data signal supplied from a data signal source to the odd-row pixel units of the column after supplying the scan signal to the odd-row pixel units of the column; the step of supplying a scan signal to another portion of the column-wise pixel units of the column of the liquid crystal display device after applying the data signal to the at least some of the pixel units comprises supplying a scan signal to the pixel units of the column of the liquid crystal display device associated with even rows after supplying the data signal to the odd-row pixel units of the column; and the step of applying the data signal supplied from the data signal source to said another portion of the pixel units to which the scan signal is supplied after supplying the scan signal to said another portion of the column-wise pixel units of the column comprises supplying a data signal supplied from the data signal source to the even-row pixel units of the column after supplying the scan signal to the even-row pixel units of the column.

The efficacy of the present invention is that to be distinguished from the state of the art, the present invention arranges first switch units and second switch units in such a way that the pixel units of a column are separately driven in multiple times so as to realize, through control of the second switch units, one channel of a data driver being shared by multiple data lines through control and the number of the data drivers used being reduced to thereby reduce the manufacturing cost.

### BRIEF DESCRIPTION OF THE DRAWINGS

FIG. 1 is a schematic view showing the structure of a known array substrate;

FIG. 2 is a front view showing a first embodiment of a liquid crystal display device according to the present invention;

FIG. 3 is a side elevational view of the liquid crystal display device shown in FIG. 2;

FIG. 4 is a circuit diagram of a first embodiment of a liquid crystal display driving circuit formed on a first substrate shown in FIG. 2;

FIG. 5 is a practical example circuit diagram of the liquid crystal display driving circuit shown in FIG. 4;

FIG. 6 is a circuit diagram of a second embodiment of a liquid crystal display driving circuit formed on the first substrate shown in FIG. 2; and

FIG. 7 is a flow chart illustrating a first embodiment of a driving method of liquid crystal display device according to the present invention.

### DETAILED DESCRIPTION OF THE PREFERRED EMBODIMENTS

A detailed description will be given hereinafter with reference to the accompanying drawings and embodiments.

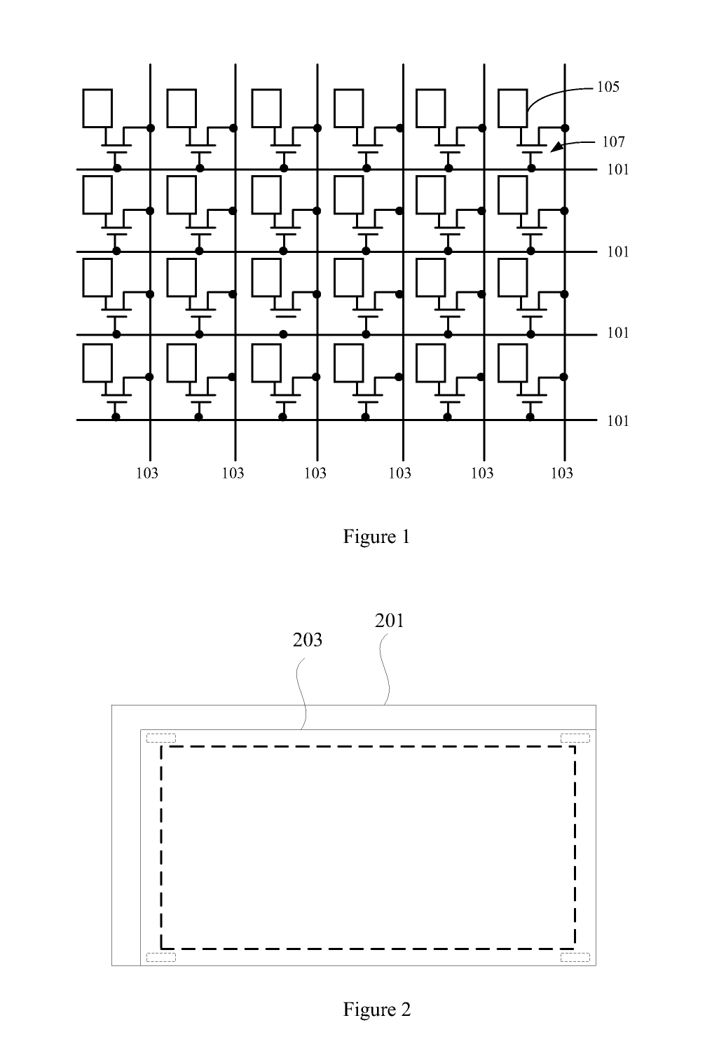

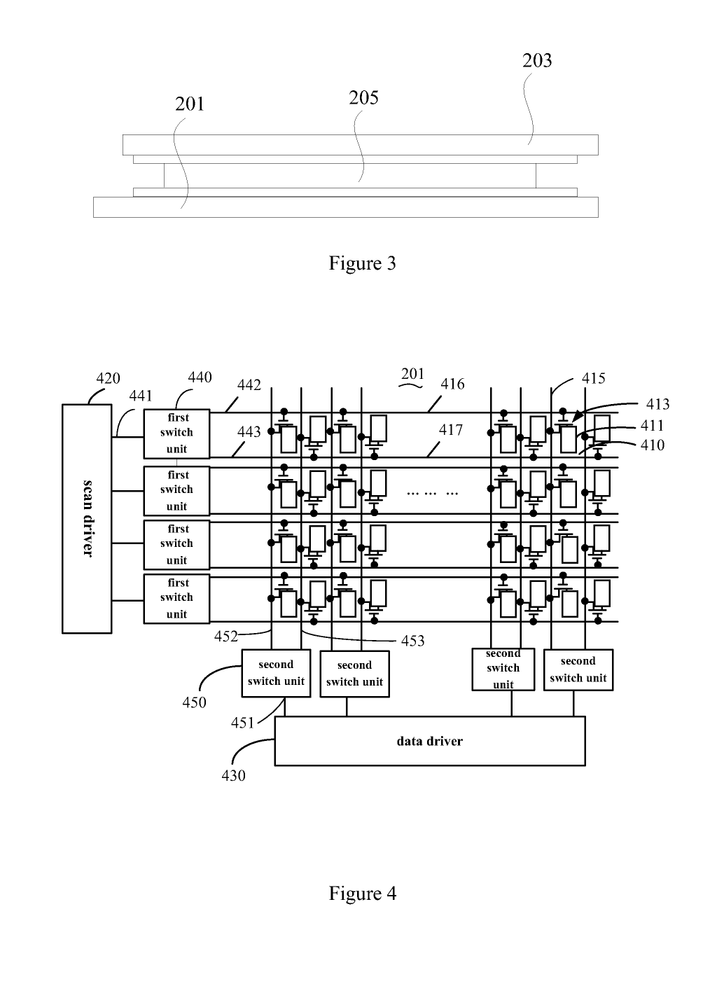

Referring to FIGS. 2 and 3, FIG. 2 is a front view showing a first embodiment of a liquid crystal display device according to the present invention. FIG. 3 is a side elevational view of the liquid crystal display device shown in FIG. 2. The first embodiment of the liquid crystal display device of the present invention comprises a first substrate 201 and a second substrate 203 that are opposite to each other and a liquid crystal layer 205 interposed between the first substrate 201 and the second substrate 203. The first substrate 201 can be an array substrate, and the second substrate 203 can be a color filter substrate.

Referring to FIG. 4, FIG. 4 is a circuit diagram of a first embodiment of a liquid crystal display driving circuit formed on the first substrate 201 shown in FIG. 2. In the instant embodiment, the first substrate 201 comprises a plurality of pixel units 410 that is arranged in an array and a plurality of scan drivers 420, a plurality of data drivers 430, a plurality of first switch units 440, and a plurality of second switch units 450 that are located outside the array of the pixel units 410.

Each of the pixel units 410 comprises a row-wise data line 415, column-wise first and second scan lines 416, 417 that intersect but is insulated from the data line 415, a pixel electrode 411 and a first thin film transistor 413 located in an area enclosed by the data lines 415 and the scan lines 416, 417. It is noted here that each the data line 415, the first scan line 416, and the second scan line 417 of the pixel units 410 are respectively connected to form complete conductive lines.

The pixel electrode 411 is located in the area enclosed by the data lines 415, the first scan line 416, and the second scan line 417.

The first thin film transistor 413 is similarly located in the are enclosed by the data lines 415, the first scan line 416, and the second scan line 417. In each column of the pixel units 410, the gate terminals of the first thin film transistors 413 associated with odd rows are electrically connected to the first scan line 416, while the gate terminals of the first thin film transistors 413 associated with the even rows are electrically connected to the second scan line 417. The source terminals of the first thin film transistors 413 are connected to the data lines 415, and the drain terminals of the first thin film transistor 413 are connected to the pixel electrodes 411.

Each of the first switch units 440 corresponds to one of the channels of the scan drivers 420 and a column of the pixel units 410 to selectively supply a scan signal from one of the channels of the scan drivers 420 to the pixel units 410 of the same column that are associated with the odd rows or the even rows. The first switch unit 440 comprises an input terminal 441, a first output terminal 442, and a second output terminal 443. The input terminal 441 of the first switch unit 440 is electrically connected to one of the channels of the scan drivers 420. The first output terminal 442 of the first switch unit 440 is electrically connected to the first scan line 416 and the second output terminal 443 of the first switch unit 440 is electrically connected to the second scan line 417.

Each of the second switch units 450 corresponds to one of channels of the data drivers 430 and two rows of the pixel units 410 to selectively supply a data signal from one of the channels of the data drivers 430 to the odd row or even row of two adjacent rows of the pixel units 410. The second switch unit 450 comprises an input terminal 451, a first output terminal 452, and a second output terminal 453. The input terminal 451 of the second switch unit 450 is electrically connected to one of the channels of the data drivers 430. The first output terminal 452 of the second switch unit 450 is electrically connected to the data line 415 of the odd row and the second output terminal 453 of the second switch unit 450 is electrically connected to the data line 415 of the even row that is adjacent to the data line 415 of the odd row.

Each of the first switch units 440 is set to correspond to one of the channels of the scan drivers 420 and a column of the pixel units 410. In other words, multiple first switch units 440 may share a scan driver 420. Each of the second switch units 450 is set to correspond to one of the channels of the data drivers 430 and two rows of the pixel units 410. In other words, multiple second switch units 450 may share a data driver 430, and the two rows of the pixel units 410 share one channel of the data driver 430 via one second switch unit 450.

It is noted that FIG. 4 shows only one scan driver 420 and one data driver 430, but in a practical application, the numbers of the scan drivers 420 and the data drivers 430 can be determined as desired.

It is appreciated that the first thin film transistor 413 can be replaced by a bipolar transistor, a Darlington transistor, or other controllable switch. The present invention imposes no specific limitation.

In addition, the first switch units 440 may not be simply arranged in such a regular way by following “even” and “odd’ to supply the scan signal from the scan drivers to the pixel units of the same column. In other embodiments, random arrangement or arrangements following other regularity may be adopted.

The instant embodiment arranges the first switch units 440 and the second switch units 450 in such a way that the pixel units of one column is divided into odd row and even row that are driven separately so as to realize multiple use of the data drivers 430 to thereby save at least one half of the channels and reduce the number of data drivers 430 used and thus reduces the manufacturing cost.

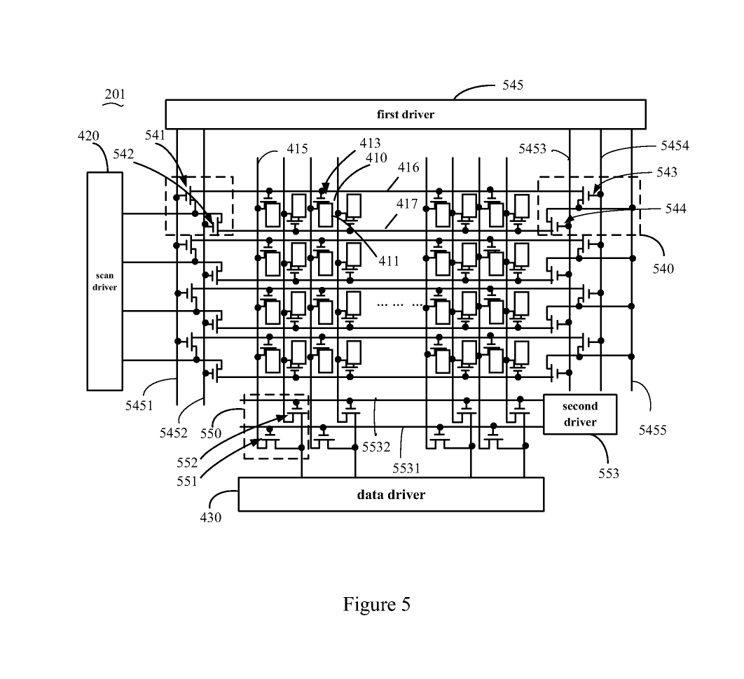

Referring to FIG. 5, FIG. 5 is a practical example circuit diagram of the liquid crystal display driving circuit shown in FIG. 4.

In the instant example of practice, differences from the first embodiment shown in FIG. 4 are as follows:

Each of the first switch units 540 comprises a first selection line 5451, a second selection line 5452, a third selection line 5453, a fourth selection line 5454, a low level signal line 5455, a first driver 545, a first field effect transistor 541, a second field effect transistor 542, a third field effect transistor 543, and a fourth field effect transistor 544.

The first selection line 5451, the second selection line 5452, the third selection line 5453, the fourth selection line 5454, and the low level signal line 5455 are arranged row-wise on the first substrate 201.

The first driver 545 is electrically connected to the first selection line 5451, the second selection line 5452, the third selection line 5453, the fourth selection line 5454, and the low level signal line 5455. The first driver 545 outputs a voltage level selection signal to the first selection line 5451, the second selection line 5452, the third selection line 5453, and the fourth selection line 5454 and supplies a low level voltage to the low level signal line 5455.

The first field effect transistor 541 has a gate terminal electrically connected to the first selection line 5451. The first field effect transistor 541 has a source terminal electrically connected to one of the channels of the scan driver 420. The first field effect transistor 541 has a drain terminal electrically connected to the first scan line 416.

The second field effect transistor 542 has a gate terminal electrically connected to the second selection line 5452. The second field effect transistor 542 has a source terminal electrically connected to one of the channels of the scan driver 420. The second field effect transistor 542 has a drain terminal electrically connected to the second scan line 417.

The third field effect transistor 543 has a gate terminal electrically connected to the third selection line 5453. The third field effect transistor 543 has a source terminal electrically connected to the low level signal line 5455. The third field effect transistor 543 has a drain terminal electrically connected to the first scan line 416.

The fourth field effect transistor 544 has a gate terminal electrically connected to the fourth selection line 5454. The fourth field effect transistor 544 has a source terminal electrically connected to the low level signal line 5455. The fourth field effect transistor 544 has a drain terminal electrically connected to the second scan line 417.

Each of the second switch units 550 comprises a fifth selection line 5531, a sixth selection line 5532, a second driver 553, a fifth field effect transistor 551, and a sixth field effect transistor 552.

The fifth selection line 5531 and the sixth selection line 5532 are arranged horizontally on the first substrate 201.

The second driver 553 is electrically connected to the fifth selection line 5531 and the sixth selection line 5532. The second driver 553 outputs a voltage level selection signal to the fifth selection line 5531 and the sixth selection line 5532.

The fifth field effect transistor 551 has a gate terminal electrically connected to the fifth selection line 5531. The fifth field effect transistor 551 has a source terminal electrically connected to one of the channels of the data driver 43. The fifth field effect transistor 551 has a drain terminal electrically connected to the data line 415 of one of the odd rows.

The sixth field effect transistor 552 has a gate terminal electrically connected to the sixth selection line 5532. The sixth field effect transistor 552 has a source terminal electrically connected to one of the channels of the data driver 430. The sixth field effect transistor 552 has a drain terminal electrically connected to the data line 415 of the adjacent even row.

The instant embodiment arranges the first switch units 440 and the second switch units 450 in such a way that the pixel units of one column is divided into odd row and even row that are driven separately so as to realize multiple use of the data drivers 430 to thereby save at least one half of the channels and reduce the number of data drivers 430 used and thus reduces the manufacturing cost.

Further, it is understood that the first switch units 440 and the second switch units 450 are not limited to the specific structures described above. Those having the ordinary skills of the art may appreciate that based on the teaching and the structures described above, other structures of the first switch unit 440 and the second switch unit 450 that provide the same or similar functions can be easily achieved with related knowledge publically available in this technical field.

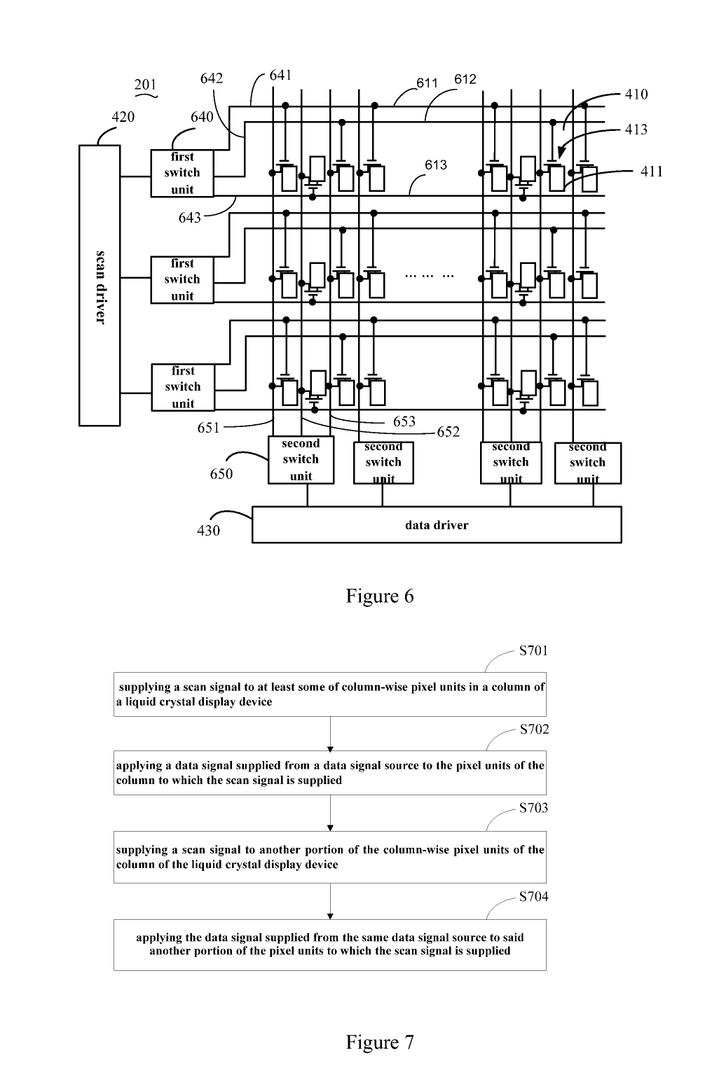

Referring to FIG. 6, FIG. 6 is a circuit diagram of a second embodiment of a liquid crystal display driving circuit formed on the first substrate 201 shown in FIG. 2. Differences of the instant embodiment from the first embodiment of FIG. 4 are as follows:

Each of the pixel units 410 comprises column-wise first, second, and third scan lines 611, 612, 613 In each column of the pixel units 410, the gate terminal of the first thin film transistor 413 of the first row is electrically connected to the first scan line 611; the gate terminal of the first thin film transistor 413 of the second row is electrically connected to the second scan line 612; and the gate terminal of the first thin film transistor 413 of the third row is electrically connected to the third scan line 613, and so forth.

Each of the first switch units 640 comprises a first output terminal 641, a second output terminal 642, and a third output terminal 643. The first output terminal 641 of the first switch unit 640 is electrically connected to the first scan line 611; the second output terminal 642 of the first switch unit 640 is electrically connected to the second scan line 612; and the third scan line 613 of the first switch unit 640 is electrically connected to the third output terminal 643.

Each of the second switch units 650 comprises a first output terminal 651, a second output terminal 652, and a third output terminal 653. The first output terminal 651 of the second switch unit 650 is electrically connected to the source terminals of the thin film transistors 413 of the first row; the second output terminal 652 of the second switch unit 650 is electrically connected to the source terminals of the thin film transistors 413 of second row; and the third output terminal 653 of the second switch unit 650 is electrically connected to the source terminals of the thin film transistors 413 of the third row.

It is appreciated that it is also feasible to arrange four or more scan lines for the pixel units discussed in the above embodiment. Under this condition, the first switch units and the second switch units are correspondingly provided with the same number of output terminals as that of the scan lines, whereby the pixel units of a column are divided into multiple groups that are separately driven in multiple driving operations so as to realize multiple use of the data drivers to save at least one half of the channels and reduce the manufacturing cost.

The present invention also provides a liquid crystal display driving circuit, which is identical to the above-described circuit and repeated description will be omitted.

According to another aspect of the present invention, the present invention provides a driving method of liquid crystal display device. Referring to FIG. 7, FIG. 7 is a flow chart illustrating a first embodiment of a driving method of liquid crystal display device according to the present invention. The driving method of the instant embodiment comprises the following steps:

Step S701: supplying a scan signal to at least some of column-wise pixel units in a column of a liquid crystal display device.

Step S702: applying a data signal supplied from a data signal source to the pixel units of the column to which the scan signal is supplied.

Step S703: supplying a scan signal to another portion of the column-wise pixel units of the column of the liquid crystal display device.

Step S704: applying the data signal supplied from the same data signal source to said another portion of the pixel units to which the scan signal is supplied.

It is noted that in the instant embodiment, the data signal source corresponds to the channels of the embodiment discussed with reference to FIG. 4.

A specific example of operation that the liquid crystal display device according to the present invention takes to realize the above driving method will be described in details.

The operation of the driving circuit and the driving method according to the present invention described above is as follows.

Referring again to FIG. 4, in the instant embodiment, the liquid crystal display device is operated in a column scanning manner. Thus, when column scanning is carried out for each frame, for example starting from the first column, a first switch unit 440 of the first column selectively supplies a scan signal to odd-row pixel units 410 of the first column and all second switch units 450 simultaneously supply data signals to the odd-row pixel units 410; the first switch unit 440 selectively supplies a scan signal to even-row pixel units 410 of the first column and all the second switch units 450 simultaneously supply data signals to the pixel units 410 of the even rows that are respectively adjacent to the odd rows. Afterwards, the above process is repeated, from the second column to the last column, to complete scanning and data input of the frame.

Referring again to FIG. 5, specifically for one channel of the data driver 430, when the first driver 545 supplies a high voltage level to the first selection line 5451 and the fourth selection line 5454 and supplies a low voltage level to the second selection line 5452, the third selection line 5453, and the low level signal line 5455, the first field effect transistor 541 and the fourth field effect transistor 544 are set on and the second field effect transistor 542 and the third field effect transistor 543 are set off, whereby one of the channels of the scan driver 420 supplies a scan signal through the first field effect transistor 541 to the first scan line 416, and a low voltage level signal supplied from the low level signal line 5455 is transmitted via the fourth field effect transistor 544 to the second scan line 417 in order to selectively supply the scan signal to the odd-row pixel units 410 of the same column.

Afterwards, when the second driver 553 supplies a high voltage level to the fifth selection line 5531 and supplies a low voltage level to the sixth selection line 5532, the fifth field effect transistor 551 is set on and the sixth field effect transistor 552 is set off, whereby a signal supplied from one of the channels of the data driver 430 is transmitted via the fifth field effect transistor 551 to the data line of one of the odd rows to selectively supply a data signal to the pixel units 410 of the same odd row.

When the first driver 545 supplies a high voltage level to the second selection line 5452 and the third selection line 5453 and supplies a low voltage level to the first selection line 5451, the fourth selection line 5454, and the low level signal line 5455, the second field effect transistor 542 and the third field effect transistor 543 are set on and the first field effect transistor 541 and the fourth field effect transistor 544 are set off, whereby a scan signal supplied from one of the channels of the scan driver 420 is transmitted via the second field effect transistor 542 to the second scan line 417, and a low voltage level signal supplied from the low level signal line 5455 is transmitted via the third field effect transistor 543 to the second scan line 417, in order to selectively supply the scan signal to the even-row pixel units 410 of the same column.

Afterwards, when the second driver 553 supplies a high voltage level to the sixth selection line 5532 and supplies a low voltage level to the sixth selection line 5531, the sixth field effect transistor 552 is set on and the fifth field effect transistor 551 is set off, whereby a signal supplied from the same channel of the data driver 430 is transmitted via the sixth field effect transistor 552 to the data line of one of the even rows that is adjacent to the said odd row in order to selectively supply a data signal to the pixel units 410 of the same even row.

The above description is given for a specific one of the channels of the data driver 430 and the remaining channels of the data driver 430, as well as the channels of other data drivers 430, if available, are all set in operation simultaneously and regularly in the same way.

In other words, in summary, in scanning each column is scanned, firstly, the first switch unit 440 of the first column selectively supplies a scan signal to the odd-row pixel units 410 of the column. Afterwards, all the second switch units 450 simultaneously supply data signals to the odd-row pixel units 410. Thereafter, the first switch unit 440 of the first column selectively supplies a scan signal to the even-row pixel units 410 of the column. Finally, all the second switch units 450 simultaneously supply data signals to the even-row pixel unit 410 to thereby complete the scanning of the first column. Then, the process is repeated to scan each column until the scanning of a frame is completed.

It is understood that when the pixel units of a specific column is divided into multiple groups for separate performance of control, the driving method is similar to the above illustration so that repeated description is omitted.

In the instant embodiment, the pixel units of a column is divided into multiple groups for being separately controlled in order to realize multiple use of data signal source and thus effectively reducing the number of data drivers used and reducing the manufacturing cost.

To be distinguished from the state of the art, the present invention arranges first switch units and second switch units in such a way that the pixel units of a column are separately driven in multiple times so as to realize, through control of the second switch units, one channel of a data driver being shared by multiple data lines through control and the number of the data drivers used being reduced to thereby reduce the manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A liquid crystal display device, comprising first and second substrates that are opposite to each other and a liquid crystal layer interposed between the first and second substrates, wherein,
the first substrate comprise a plurality of pixel units that is arranged in an array having columns and rows and a plurality of scan drivers, a plurality of data drivers, a plurality of first switch units, and a plurality of second switch units that are located outside the array of the pixel units;
each of the pixel units comprises a row-wise data line, column-wise first and second scan lines, a pixel electrode and a controllable switch located in an area enclosed by the data lines and the scan lines, wherein in each column of the pixel units, control terminals of the controllable switches of odd rows are electrically connected to the first scan line, control terminals of the controllable switches of even rows are electrically connected to the second scan line, input terminals of the controllable switches are electrically connected to the data lines, and output terminals of the controllable switches are electrically connected to the pixel electrode, in which the controllable switches are first thin film transistors;
each of the first switch units corresponds to one of the channels of the scan drivers and a column of the pixel units, each of the first switch units comprising an input terminal, a first output terminal, and a second output terminal, the input terminal of the first switch unit being electrically connected to one of the channels of the scan drivers, the first output terminal of the first switch unit being electrically connected to the first scan line, the second output terminal of the first switch unit being electrically connected to the second scan line in order to selectively supply a scan signal from one of the channels of the scan drivers to the pixel units of the same column that are associated with the odd rows or the even rows;
each of the second switch units corresponds to one of channels of the data drivers and two rows of the pixel units, each of the second switch units comprising an input terminal, a first output terminal, and a second output terminal, the input terminal of the second switch unit being electrically connected to one of the channels of the data drivers, the first output terminal of the second switch unit being electrically connected to the data line of an odd row, the second output terminal of the second switch unit being electrically connected to the data line of an adjacent even row, in order to selectively supply a data signal from one of the channels of the data drivers to the adjacent odd row or even row of the pixel units;
the first switch unit comprises:
a first selection line, a second selection line, a third selection line, a fourth selection line, and a low level signal line that are arrange row-wise;
a first driver supplying a voltage level selection signal to the first selection line, the second selection line, the third selection line, and the fourth selection line and supplying a low level voltage to the low level signal line;
a first field effect transistor having a gate terminal electrically connected to the first selection line, the first field effect transistor having a source terminal electrically connected to one of the channels of the scan driver, the first field effect transistor having a drain terminal electrically connected to the first scan line;
a second field effect transistor having a gate terminal electrically connected to the second selection line, the second field effect transistor having a source terminal electrically connected to the channel of the scan driver, the second field effect transistor having a drain terminal electrically connected to the second scan line;
a third field effect transistor having a gate terminal electrically connected to the third selection line, the third field effect transistor having a source terminal electrically connected to the low level signal line, the third field effect transistor having a drain terminal electrically connected to the first scan line; and
a fourth field effect transistor having a gate terminal electrically connected to the fourth selection line, the fourth field effect transistor having a source terminal electrically connected to the low level signal line, the fourth field effect transistor having a drain terminal electrically connected to the second scan line;
wherein when the first driver supplies a high voltage level to the first selection line and the fourth selection line and supplies a low voltage level to the second selection line, the third selection line, and the low level signal line, the first field effect transistor and the fourth field effect transistor are set on and the second field effect transistor and the third field effect transistor are set off, whereby a scan signal supplied from one of the channels of the scan drivers is transmitted via the first field effect transistor to the first scan line and a low voltage level signal supplied from the low level signal line is transmitted via the fourth field effect transistor to the second scan line in order to selectively supply the scan signal to the odd-row pixel units of the same column; and
when the first driver supplies a high voltage level to the second selection line and the third selection line and supplies a low voltage level to the first selection line, the fourth selection line, and the low level signal line, the second field effect transistor and the third field effect transistor are set on and the first field effect transistor and the fourth field effect transistor are set off, whereby a scan signal supplied from the channel of the scan driver is transmitted via the second field effect transistor to the second scan line and a low voltage level signal supplied from the low level signal line is transmitted via the third field effect transistor to the first scan line in order to selectively supply the scan signal to the even-row pixel units of the same column;
the second switch unit comprises:
a fifth selection line and a sixth selection line that are arranged column-wise;
a second driver supplying a voltage level selection signal to the fifth selection line or the sixth selection line;
the fifth field effect transistor having a gate terminal electrically connected to the fifth selection line, the fifth field effect transistor having a source terminal electrically connected to one of the channels of the data driver, the fifth field effect transistor having a drain terminal electrically connected to the data line of one of the odd rows; and
the sixth field effect transistor having a gate terminal electrically connected to the sixth selection line, the sixth field effect transistor having a source terminal electrically connected to the channel of the data driver, the sixth field effect transistor having a drain terminal electrically connected to the data line of the adjacent even row;
wherein when the second driver supplies a high voltage level to the fifth selection line and supplies a low voltage level to the sixth selection line, the fifth field effect transistor is set on and the sixth field effect transistor is set off, whereby a signal supplied from one of the channels of the data driver is transmitted via the fifth field effect transistor to the data line of one of the odd rows to selectively supply a data signal to the pixel units of the same odd row; and
when the second driver supplies a high voltage level to the sixth selection line and supplies a low voltage level to the sixth selection line, the sixth field effect transistor is set on and the fifth field effect transistor is set off, whereby a signal supplied from the channel of the data driver is transmitted via the sixth field effect transistor to the data line of an adjacent even row in order to selectively supply a data signal to the pixel units of the same even row.

2. The device as claimed in claim 1, wherein each of the second switch units corresponds to two rows of the pixel units.

3. A liquid crystal display driving circuit, comprising: a plurality of scan drivers, a plurality of data drivers, a plurality of first switch units, and a plurality of second switch units that are located outside an array of pixel units of a liquid crystal display device;
each of the pixel units comprises a row-wise data line, at least two column-wise scan lines, a pixel electrode and a controllable switch located in an area enclosed by the data lines and the scan lines, wherein in each column of the pixel units, a control terminal of each of the controllable switches is electrically connected to one the scan lines, input terminals of the controllable switches are electrically connected to the data lines, and output terminals of the controllable switches are electrically connected to the pixel electrode;
each of the first switch units corresponds to one of the channels of the scan drivers and a column of the pixel units, each of the first switch units comprising an input terminal and at least two output terminals, the input terminal of the first switch unit being electrically connected to one of the channels of the scan drivers, the output terminals of the first switch unit being respectively and electrically connected to the scan lines in order to selectively supply a scan signal from one of the channels of the scan drivers to the pixel units of the same column that are electrically connected with one of the scan lines; and
each of the second switch units corresponds to one of channels of the data drivers and at least two rows of the pixel units, each of the second switch units comprising an input terminal and at least two output terminals, the input terminal of the second switch unit being electrically connected to one of the channels of the data drivers, each of the output terminals of the second switch unit being electrically connected to one of the data lines in order to selectively supply a data signal from one of the channels of the data drivers to the pixel units of one row of the at least two rows of pixel units to which the scan signal is supplied.

4. The circuit as claimed in claim 3, wherein
the controllable switches comprise first thin film transistors;
each of the pixel units comprises column-wise first and second scan lines, wherein in each column of the pixel units, gate terminals of the first thin film transistors of the odd rows are electrically connected to the first scan line and gate terminals of the thin film transistors of the even rows are electrically connected to the second scan line;
each of the first switch units comprises a first output terminal and a second output terminal, the first output terminal of the first switch unit being electrically connected to the first scan line, the second output terminal of the first switch unit being electrically connected to the second scan line in order to selectively supply a scan signal from one of the channels of the scan drivers to the pixel units of the same column that are associated with the odd rows or the even rows;
each of the second switch units comprises a first output terminal and a second output terminal, the first output terminal of the second switch unit being electrically connected to the data line of an odd row, the second output terminal of the second switch unit being electrically connected to the data line of an adjacent even row, in order to selectively supply a data signal from one of the channels of the data drivers to the adjacent odd row or even row of the pixel units;
wherein when the first switch unit selectively supplies a scan signal to the odd-row pixel units of one column, the second switch units selectively supply data signals to the odd rows of the pixel units; and when the first switch unit selectively supplies a scan signal to the even-row pixel units of the same column, the second switch units selectively supply data signals to the even rows of the pixel units.

5. The circuit as claimed in claim 4, wherein
the first switch unit comprises:
a first selection line, a second selection line, a third selection line, a fourth selection line, and a low level signal line that are arrange row-wise;
a first driver supplying a voltage level selection signal to the first selection line, the second selection line, the third selection line, and the fourth selection line and supplying a low level voltage to the low level signal line;
a first field effect transistor having a gate terminal electrically connected to the first selection line, the first field effect transistor having a source terminal electrically connected to one of the channels of the scan driver, the first field effect transistor having a drain terminal electrically connected to the first scan line;
a second field effect transistor having a gate terminal electrically connected to the second selection line, the second field effect transistor having a source terminal electrically connected to the channel of the scan driver, the second field effect transistor having a drain terminal electrically connected to the second scan line;
a third field effect transistor having a gate terminal electrically connected to the third selection line, the third field effect transistor having a source terminal electrically connected to the low level signal line, the third field effect transistor having a drain terminal electrically connected to the first scan line; and
a fourth field effect transistor having a gate terminal electrically connected to the fourth selection line, the fourth field effect transistor having a source terminal electrically connected to the low level signal line, the fourth field effect transistor having a drain terminal electrically connected to the second scan line;
wherein when the first driver supplies a high voltage level to the first selection line and the fourth selection line and supplies a low voltage level to the second selection line, the third selection line, and the low level signal line, the first field effect transistor and the fourth field effect transistor are set on and the second field effect transistor and the third field effect transistor are set off, whereby a scan signal supplied from one of the channels of the scan drivers is transmitted via the first field effect transistor to the first scan line and a low voltage level signal supplied from the low level signal line is transmitted via the fourth field effect transistor to the second scan line in order to selectively supply the scan signal to the odd-row pixel units of the same column; and
when the first driver supplies a high voltage level to the second selection line and the third selection line and supplies a low voltage level to the first selection line, the fourth selection line, and the low level signal line, the second field effect transistor and the third field effect transistor are set on and the first field effect transistor and the fourth field effect transistor are set off, whereby a scan signal supplied from the channel of the scan driver is transmitted via the second field effect transistor to the second scan line and a low voltage level signal supplied from the low level signal line is transmitted via the third field effect transistor to the first scan line in order to selectively supply the scan signal to the even-row pixel units of the same column.

6. The circuit as claimed in claim 4, wherein
the second switch unit comprises:
a fifth selection line and a sixth selection line that are arranged column-wise;
a second driver supplying a voltage level selection signal to the fifth selection line or the sixth selection line;
the fifth field effect transistor having a gate terminal electrically connected to the fifth selection line, the fifth field effect transistor having a source terminal electrically connected to one of the channels of the data driver, the fifth field effect transistor having a drain terminal electrically connected to the data line of one of the odd rows; and
the sixth field effect transistor having a gate terminal electrically connected to the sixth selection line, the sixth field effect transistor having a source terminal electrically connected to the channel of the data driver, the sixth field effect transistor having a drain terminal electrically connected to the data line of the adjacent even row;
wherein when the second driver supplies a high voltage level to the fifth selection line and supplies a low voltage level to the sixth selection line, the fifth field effect transistor is set on and the sixth field effect transistor is set off, whereby a signal supplied from one of the channels of the data driver is transmitted via the fifth field effect transistor to the data line of one of the odd rows to selectively supply a data signal to the pixel units of the same odd row; and
when the second driver supplies a high voltage level to the sixth selection line and supplies a low voltage level to the sixth selection line, the sixth field effect transistor is set on and the fifth field effect transistor is set off, whereby a signal supplied from the channel of the data driver is transmitted via the sixth field effect transistor to the data line of an adjacent even row in order to selectively supply a data signal to the pixel units of the same even row.

7. The circuit as claimed in claim 3, wherein each of the second switch units corresponds to two rows of the pixel units.

8. A method for driving liquid crystal display device, comprising the following steps:
supplying a scan signal to at least some of column-wise pixel units in a column of a liquid crystal display device;
applying a data signal supplied from a data signal source to the pixel units of the column to which the scan signal is supplied after supplying the scan signal to the at least some of the column-wise pixel units of the column;
supplying a scan signal to another portion of the column-wise pixel units of the column of the liquid crystal display device after applying the data signal to the at least some of the pixel units; and
applying the data signal supplied from the data signal source to said another portion of the pixel units to which the scan signal is supplied after supplying the scan signal to said another portion of the column-wise pixel units of the column.

9. The method as claimed in claim 8, wherein
the step of supplying a scan signal to at least some of column-wise pixel units in a column of a liquid crystal display device comprises supplying the scan signal to the pixel units of the column of the liquid crystal display device that are associated with odd rows;
the step of applying a data signal supplied from a data signal source to the pixel units of the column to which the scan signal is supplied after supplying the scan signal to the at least some of the column-wise pixel units of the column comprises supplying a data signal supplied from a data signal source to the odd-row pixel units of the column after supplying the scan signal to the odd-row pixel units of the column;
the step of supplying a scan signal to another portion of the column-wise pixel units of the column of the liquid crystal display device after applying the data signal to the at least some of the pixel units comprises supplying a scan signal to the pixel units of the column of the liquid crystal display device associated with even rows after supplying the data signal to the odd-row pixel units of the column; and
the step of applying the data signal supplied from the data signal source to said another portion of the pixel units to which the scan signal is supplied after supplying the scan signal to said another portion of the column-wise pixel units of the column comprises supplying a data signal supplied from the data signal source to the even-row pixel units of the column after supplying the scan signal to the even-row pixel units of the column.
